(19) United States
(12) Patent Application Publication
(10) Pub. No.: US 2012/0050607 A1
(43) Pub. Date: Mar. 1, 2012

(54) PORTABLE SENSOR

(75) Inventors: G. Craig Sims, Inman, SC (US); Mark Hardin, Boiling Springs, SC (US)

(73) Assignee: Rhino Outdoors, LLC, Boiling Springs, SC (US)

(21) Appl. No.: 12/870,272

(22) Filed: Aug. 27, 2010

(51) Int. Cl. H04N 5/225

(52) U.S. Cl. 348/373; 348/E05.026

(57) ABSTRACT

A device for attaching to a bill of a hat to capture images includes a casing, a sensor disposed in the casing for capturing images outside the casing, and means for directing the sensor with respect to said casing. A first memory is disposed in the casing and connected to the sensor, and means exists for attaching the casing to the bill of the hat.

### FIELD OF THE INVENTION

The present invention relates generally to a portable sensor. In particular, the present disclosure describes and enables a portable sensor that may be mounted to a bill or brim of a hat for capturing images.

### BACKGROUND OF THE INVENTION

The police, military, sports enthusiasts, and others often desire to capture images of events for subsequent viewing, analysis, or study. For example, various infrared or optical sensors are often used to capture video or still images of criminal activities, military operations, or sporting events. In some instances, the sensor is permanently or temporarily mounted in a specific location selected to provide the sensor with an optimum viewing perspective of the anticipated event so the sensor can be in position to capture the desired images. However, the specific location and/or timing of the events may be unpredictable or difficult to reliably predict. As a result, the sensor must be sufficiently mobile to be relocated as desired to capture the desired images.

Attempts have been made to increase the mobility of the various sensors. For example, the sensor may be reduced in size for easy carrying by a user. Once the user detects or observes a specific event, the user may then manually position or aim the sensor as desired to allow the sensor to capture the desired images. However, even though a smaller sensor is more portable, it still requires the user to hold and operate the sensor, thus limiting the user's ability to perform other activities requiring both hands. For example, the police, military, and sports enthusiasts generally require both hands to perform various activities associated with their endeavors, and holding a portable sensor naturally sacrifices their ability to use both hands.

Therefore, the need exists for a portable sensor that can be readily carried by a user without requiring the user to hold the sensor during operations. Ideally, the portable sensor can readily travel with the user, be easily aimed by the user at the desired event, and can reliably capture the desired images of the event for subsequent viewing, analysis, or study.

### BRIEF DESCRIPTION OF THE INVENTION

Aspects and advantages of the invention are set forth below in the following description, or may be obvious from the description, or may be learned through practice of the invention.

One embodiment of the present invention is a device for attaching to a bill of a hat to capture images. The device includes a casing having a top surface and a bottom surface. The device further includes a sensor disposed in the casing for capturing images outside the casing and means for directing the sensor with respect to said casing. A first memory is disposed in the casing and connected to the sensor, and means exists for attaching the casing to the bill of the hat.

Another embodiment of the present invention is a device for attaching to a bill of a hat to capture images that includes a casing that defines an area and includes a curved top surface. A sensor is disposed at least partially inside the area defined by the casing. A first memory is disposed inside the area defined by the casing and connected to the sensor. The device further includes means for attaching said casing to the bill of the hat.

A still further embodiment of the present invention is a device for attaching to a bill of a hat to capture images. The device includes a casing that defines a volume and includes a curved top surface and a curved bottom surface. A sensor is disposed at least partially inside the volume defined by the casing. A first memory is disposed inside the volume defined by the casing and connected to the sensor. The device further includes means for attaching said casing to the bill of the hat.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying Figures, in which:

FIG. 1 shows a front top perspective view of one embodiment of the present invention;

FIG. 2 shows a rear top perspective view of the embodiment shown in FIG. 1;

FIG. 3 shows a transparent top plan view of the embodiment shown in FIG. 1;

FIG. 4 shows a transparent bottom plan view of the embodiment shown in FIG. 1;

FIG. 5 shows a front plan view of the embodiment shown in FIG. 1; and

FIG. 6 shows a rear plan view of the embodiment shown in FIG. 1.

### DETAILED DESCRIPTION OF THE INVENTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

Various embodiments of the present invention provide a device for attaching to a bill or brim of a hat to capture images. By attaching the device to the bill or brim of the hat, the sensor may be generally aimed by a user according to the direction in which the user is looking. The images may take any form that may be subsequently viewed for any reason. For example, the captured images may be subsequently viewed for pleasure, for detailed analysis, or for other study of the captured images. The captured images may reside in the device in various formats. For example, the captured images may reside in analog or digital formats such as digital video, MP3, MPEG-4, still images, or any other format currently known or to be developed, and embodiments of the present invention are not limited to any particular analog or digital format unless specifically recited in the claims. In addition, the images may be captured in real time speed, or they may be captured in slow-motion or high-speed, depending on the anticipated use of the captured images.

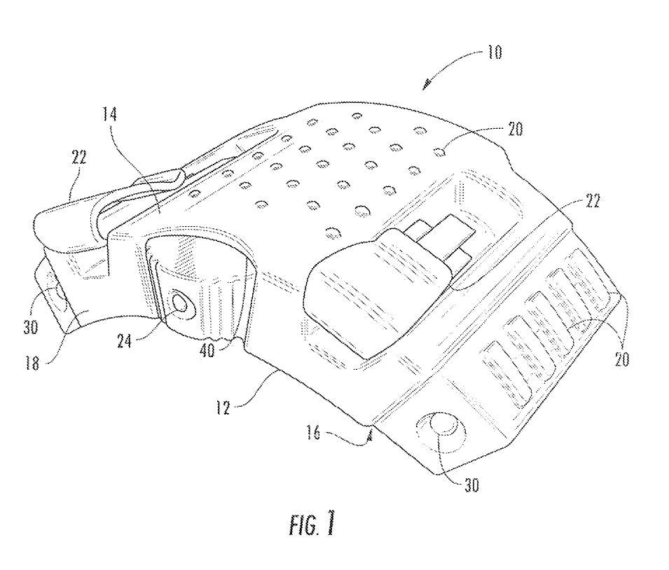

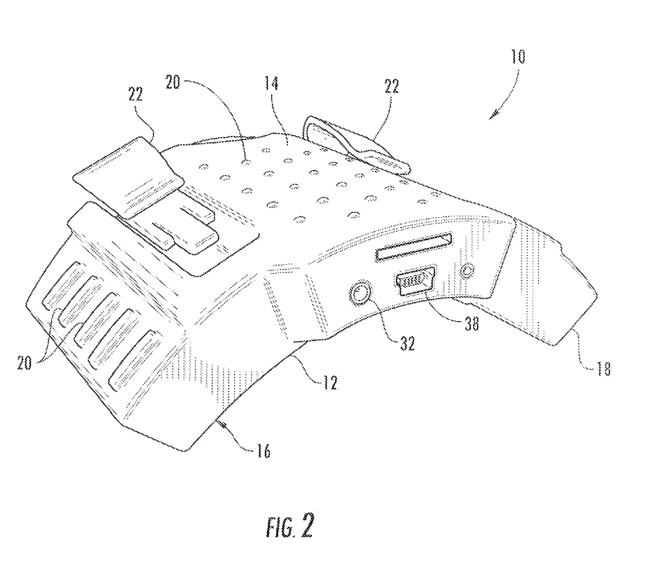

FIGS. 1 and 2 show front and rear top perspective views, respectively, of one embodiment of a device 10 for attaching to the bill or brim of the hat to capture images. As shown in FIGS. 1 and 2, the device can generally includes a casing 12 and means for attaching the casing to the bill of the hat. The casing 12 provides an enclosure and protection for various components included in the device can. In addition, in particular embodiments, the casing 12 may provide a waterproof or water resistant protective barrier for internal components in the device. The casing 12 generally includes a top surface 14 and a bottom surface 16. The top and bottom surfaces 14, 16 generally define an area within the casing 12. As shown in FIGS. 1 and 2, in particular embodiments, the casing 12 may include sides 18 that defines a volume inside the casing 12. The top and/or bottom surfaces 14, 16 are generally curved to conform to the curvature of the bill or brim of the hat to reduce any visual obstruction that the device 10 may cause to the user of the hat. In addition, as shown in FIGS. 1 and 2, the outer surface of the casing 12 may include a plurality of projections 20 on the top and/or bottom surfaces 14, 16 of the casing 12 that assist in gripping and handling the device 10. The casing 12 is generally made from lightweight materials to reduce the total weight of the device 10. For example, the casing 12 may be made from aluminum, plastic, fiberglass, resin, or other lightweight materials known to one of ordinary skill in the art.

The means for attaching the casing 12 to the bill of the hat may include any structure known in the art for readily attaching or clipping objects together, such as, for example, one or more clips, clamps, clasps, or similar devices. For example, as shown in FIGS. 1 and 2, the means for attaching the casing 12 to the bill of the hat may comprise one or more biased metallic or plastic clips 22 attached to the front top of the casing 12 that extend rearward along the top of the casing 12. In this manner, the user may lift the biased clips 22 and slide the device 10 onto the bill of the hat, and the biased tension in the clips 22 securely holds the device 10 in place under the bill of the hat during use. In alternate embodiments, the means for attaching the casing to the bill of the hat may be located on the bottom of the casing 12 so that the device 10 is held in place on top of the bill of the hat during use.

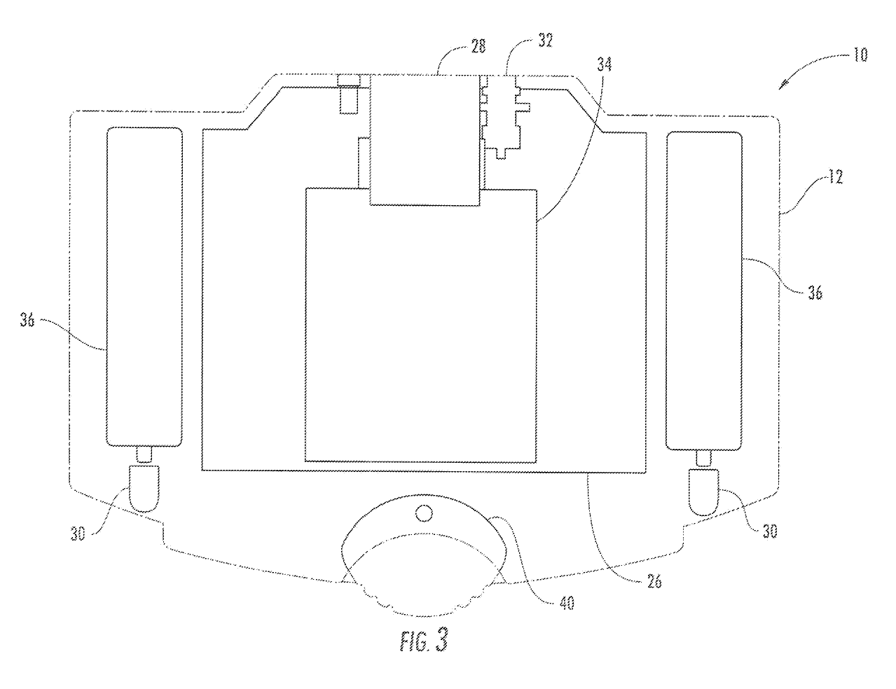

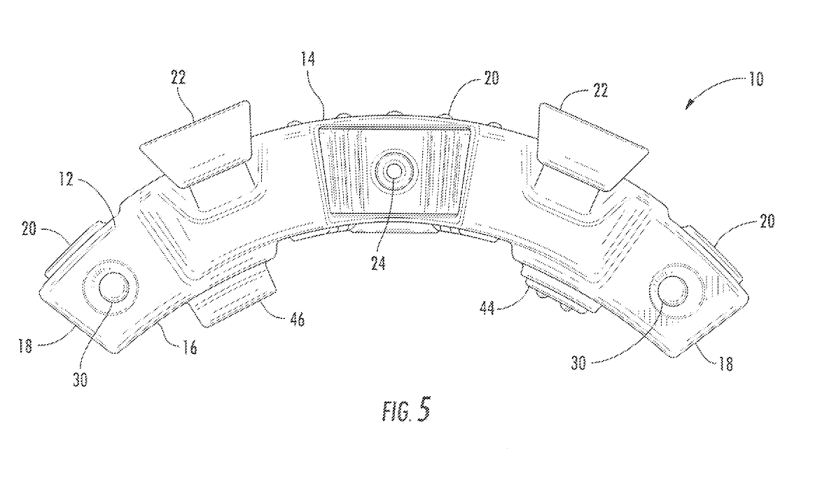

FIGS. 3, 4, 5, and 6 show various plan views of the embodiment shown in FIGS. 1 and 2 to illustrate the various components disposed in the casing 12. As used herein, the phrase “disposed in” in reference to the casing 12 means located inside the area or volume defined by the casing 12 and/or located in the surface or perimeter of the casing 12. As shown in FIGS. 1 through 6, the device 10 further generally includes a sensor 24 connected to a first memory 26. Particular embodiments may also include any combination of a second memory 28, one or more illuminators 30, a microphone 32, one or more power supplies 34, 36, and/or a communications port 38.

The sensor 24 is disposed in the casing 12 and captures images from outside the casing 12 for subsequent viewing, entertainment, and/or analysis. The sensor 24 may comprise any suitable instrument for detecting and transmitting a suitable image or other information to the first and/or memory 26, 28. For example, the sensor 24 may comprise an infrared detector that detects and transmits infrared light to the first memory 26. In other embodiments, the sensor 24 may comprise an optical lens for use with visible light images, a thermal sensor, or any other suitable instrument known to one of ordinary skill in the art. For example, a suitable sensor 24 within the scope of the present invention may be a miniature digital video camera made by Leopard Imaging and identified by item number LI-5M04CM. This digital video camera has dimensions of approximately 10 mm by 10 mm by 8.7 mm and a weight of approximately 5 g. Depending on the particular sensor 24 used, the sensor 24 may include various features, such as magnification or sensitivity, which may be adjusted by the user.

The sensor 24 may include means for directing the sensor 24 with respect to the casing 12. The means for directing the sensor 24 with respect to the casing 12 may include any mechanical connection between the sensor 24 and the casing 12 that allows relative motion between the two. For example, as shown most clearly in FIGS. 3, 4, and 5, the means for directing the sensor 24 with respect to the casing 12 may include complementary surfaces 40 that provide a sliding engagement between the sensor 24 and the casing 12. In this manner, the user may manually turn or rotate the sensor 24 with respect to the casing 12 to direct the sensor 24 to a point other than directly in front of the casing 12. For example, with the device 10 attached to the bill of the hat, the user may prefer to direct the sensor 24 at a particular angle with respect to the bill of the hat to facilitate capturing images that are not directly in front of the user.

The first and second memory 26, 28 are disposed in the casing 12 and store video images and/or still images captured by the sensor 24. The first and second memory 26, 28 may include various components such as microprocessors, coprocessors, and/or memory/media elements that store data, store software instructions, and/or execute software instructions. The various memory/media elements may be one or more varieties of computer readable media, such as, but not limited to, any combination of volatile memory (e.g., RAM, DRAM, SRAM, etc.), non-volatile memory (e.g., flash drives, hard drives, magnetic tapes, CD-ROM, DVD-ROM, etc.), and/or other memory devices (e.g., diskettes, magnetic based storage media, optical storage media, etc.). Any possible variations of data storage and processor configurations will be appreciated by one of ordinary skill in the art. For example, as shown in FIG. 3, the first memory 26 may comprise a microprocessor, and the second memory 28 may comprise a removable SD card. A suitable microprocessor within the scope of the present invention may be a Digital Media System-on-Chip (DMSoC) made by Texas instruments and identified by item number TMS320DM355. This microprocessor may operate at a frequency of approximately 270 MHz and may include internal storage or memory, such as 64 kB.

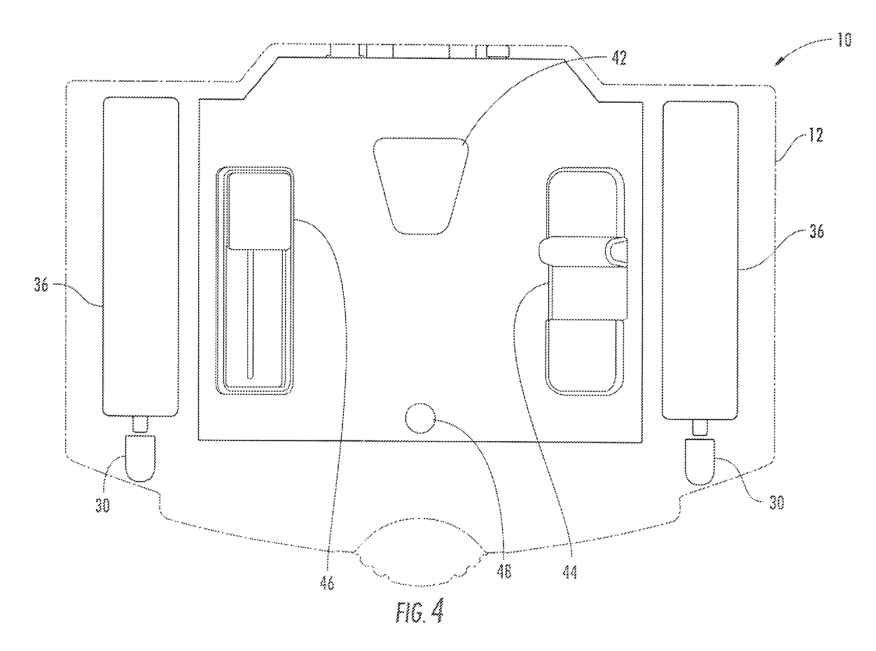

The one or more illuminators 30 are disposed in the casing 12 for illuminating objects outside the casing 12. The one or more illuminators 30 may comprise infrared and/or optical lights, such as light emitting diodes, incandescent lights, or xenon lights. As shown in FIGS. 3 and 4, the one or more illuminators 30 may include a separate power supply, such as replaceable or rechargeable batteries 36. The one or more illuminators 30 may operate in concert with or independently of the remainder of the components in the device 10.

The microphone 32 is disposed in the casing 12 and connected to at least one of the first and/or second memory 26, 28. As is known in the art, the microphone 32 captures audio information contemporaneously with the captured images for subsequent listening, entertainment, and/or analysis.

FIG. 3 also illustrates the power supply 34 disposed inside the casing 12. The power supply 34 may include a replaceable or rechargeable lithium battery that provides power to some or all of the components within the device 10. For example, as shown in FIG. 3, the power supply 34 provides dedicated power only to the sensor 24 and/or the first and second memory 26, 28. A suitable power supply 34 within the scope of the present invention may include a DC/DC converter made by Texas Instruments and identified by item number TPS65053RGE.

As shown most clearly in FIG. 4, the device 10 may include one or more switches or buttons that may be operated by the user for quick and easy operation of various features of the device 10. For example, a control 42 on the bottom surface 16 of the casing 12 may be used to operate the sensor 24 and/or the first memory 26. The control 42 may comprise a rotary switch or a pushbutton, as shown in FIG. 4. By way of example, depressing the pushbutton once may turn the device 10 on and place it in standby; depressing the pushbutton a second time may activate the sensor 24 to capture images; depressing the pushbutton a third time may return the device 10 to standby; depressing the pushbutton for a prolonged period, for example for 3 seconds, may turn the device 10 off. A separate switch 44 may be used to toggle the one or more illuminators 30 on or off. A zoom controller 46 on the bottom surface 16 of the casing 12 may allow the user to adjust the sensitivity or magnification of the sensor 24. For example, sliding the zoom controller 46 in either direction may increase or decrease the sensitivity or magnification of the sensor 24.

The device 10 may further include a status light 48 on the bottom surface 16 of the casing 12 that is readily visible to the user when the device 10 is installed on the bill of the hat. For example, the status light 48 may rapidly flash on and off to indicate that the device 10 is in standby and remain on to indicate that the sensor 24 is capturing images. In particular embodiments, the status light 48 may also indicate the charging status of the power supply 34 while the power supply 34 is being recharged.

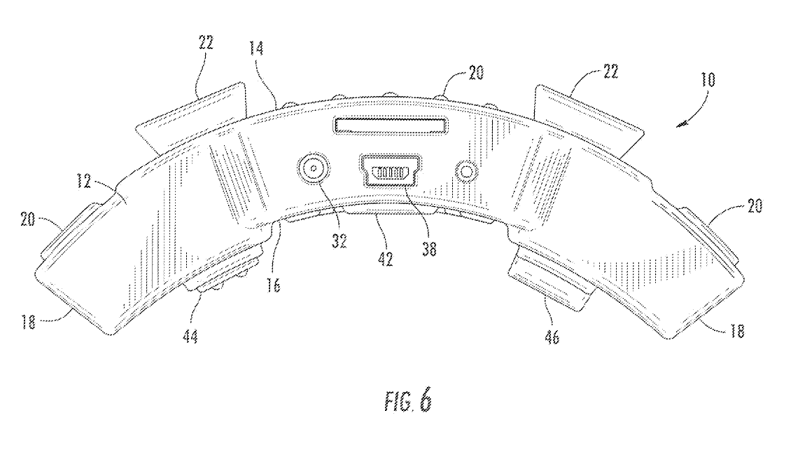

FIG. 6 provides a rear plan view of the embodiment shown in FIG. 1. As shown in FIG. 6, the communications port allows communication between the first and/or second memory to an external device such as, for example, a television, a computer, and/or a hard drive. The communications port 38 may comprise a USB connection, a FireWire connection, a DV connection, or other similar connection for allowing the device 10 to communicate with external components. In addition, the communications port 38 may be used to supply power to the power supply 34 to recharge the power supply 34 as previously described.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A device for attaching to a bill of a hat to capture images, comprising:
a. a casing having a top surface and a bottom surface;
b. a sensor disposed in said casing for capturing images outside said casing;
c. means for directing said sensor with respect to said casing;
d. a first memory disposed in said casing and connected to said sensor; and
e. means for attaching said casing to the bill of the hat.

2. The device as in claim 1, wherein at least one of said top or bottom surfaces are curved.

3. The device as in claim 1, further including a second memory disposed in said casing, wherein said second memory stores still images.

4. The device as in claim 1, further including a microphone disposed in said casing.

5. The device as in claim 1, further including at least one illuminator disposed in said casing for illuminating objects outside said casing.

6. The device as in claim 1, further including a power supply disposed in said casing, wherein said power supply provides power to at least one of said sensor or said first memory.

7. The device as in claim 1, further including a communications port disposed in said casing.

8. The device as in claim 1, further including a control on said bottom surface of said casing, wherein said control operates at least one of said sensor or said first memory.

9. The device as in claim 1, further including a zoom controller on said bottom surface of said casing, wherein said zoom controller operates said sensor.

10. A device for attaching to a bill of a hat to capture images, comprising:
a. a casing, wherein said casing defines an area and includes a curved top surface;
b. a sensor disposed at least partially inside said area defined by said casing;
c. a first memory disposed inside said area defined by said casing and connected to said sensor; and
d. means for attaching said casing to the bill of the hat.

11. The device as in claim 10, further including means for directing said sensor with respect to said casing.

12. The camera as in claim 10, wherein said sensor is an infrared sensor.

13. The device as in claim 10, further including at least one illuminator disposed in said casing for illuminating objects outside said casing.

14. The device as in claim 10, further including a power supply disposed in said casing, wherein said power supply provides power to at least one of said sensor or said first memory.

15. A device for attaching to a bill of a hat to capture images, comprising:
a. a casing, wherein said casing defines a volume and includes a curved top surface and a curved bottom surface;
b. a sensor disposed at least partially inside said volume defined by said casing;
c. a first memory disposed inside said volume defined by said casing and connected to said sensor; and
d. means for attaching said casing to the bill of the hat.

16. The device as in claim 15, further including means for directing said sensor with respect to said casing.

17. The device as in claim 15, further including at least one illuminator disposed in said casing for illuminating objects outside said casing.

18. The device as in claim 15, further including a power supply disposed in said casing, wherein said power supply provides power to at least one of said sensor or said first memory.

19. The device as in claim 15, further including a control on said bottom surface of said casing, wherein said control operates at least one of said sensor or said first memory.

20. The device as in claim 15, further including a zoom controller on said bottom surface of said casing, wherein said zoom controller operates said sensor.
